(19) United States
(12) Patent Application Publication
(10) Pub. No.: US 2008/0093483 A1
(43) Pub. Date: Apr. 24, 2008

(54) Fuel Injector with Direct, Multi-Stage Injection Valve Member Control

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/632,973

(22) PCT Filed: May 13, 2005
(86) PCT No.: PCT/EP05/52201

§ 371 Date: Jan. 19, 2007

(30) Foreign Application Priority Data
Jul. 21, 2004 (DE) 10 2004 035 280.1

(51) Int. Cl. F02M 51/06

(52) U.S. Cl. 239/585.5

(57) ABSTRACT

A fuel injector having an injection valve member for injecting fuel into the combustion chamber of an autoignition internal combustion engine. The injection valve member is directly controllable by means of an actuator that directly actuates a pressure booster, which is able to influence the pressure in a control chamber that acts on the injection valve member. The pressure booster has a first booster piston and a second booster piston coupled to each other by means of a driver that is able to move between a first stop side and a second stop side inside a recess.

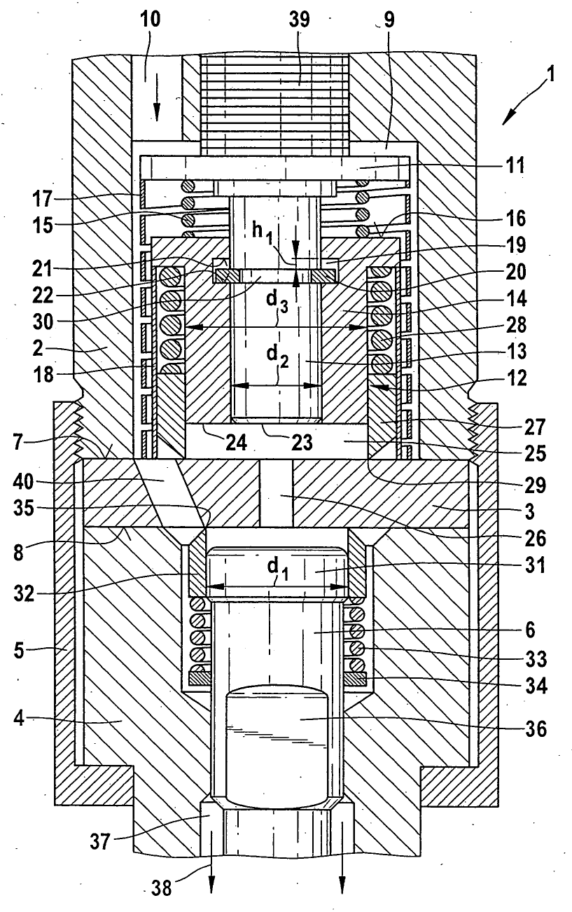

### TECHNICAL FIELD

In modern autoignition internal combustion engines, in addition to unit injector fuel injection systems, high-pressure accumulator (common rail) systems are also used. In high-pressure accumulator injection systems, a high-pressure accumulator (common rail) supplies fuel to the individual fuel injectors associated with the respective cylinders of the internal combustion engine. The fuel injectors can be actuated either a means of solenoid valves or by means of piezoelectric actuators. If the fuel injectors are actuated by means of piezoelectric actuators, then it is possible to implement an injection valve member that can be actuated directly by means of the piezoelectric actuator.

### PRIOR ART

An injection valve member is known from DE 697 20 145 C2. The injection valve includes a valve needle that a spring contained in a spring chamber presses against a seat valve. The spring is embedded between a moving stop and a spring support that is connected to the valve needle. A narrowed through-flow path is provided, through which fuel can flow out of the spring chamber at a limited speed and/or quantity. The injection valve also has a valve that includes a moving stop surface; this valve can be actuated during operation of the injection valve in such a way that fuel can emerge from the spring chamber at a second, higher speed and/or quantity. The valve is comprised of a seat surface surrounding an opening that communicates with the spring chamber; the moving stop is able to come into contact with the seat surface, making it possible to control the flow of fuel through the opening. It is possible to embody the moving stop so that it can move in reaction to the influence of the fuel pressure inside a pump chamber.

In fuel injectors in which an actuator is able to actuate the injection valve member directly, in order to be able to open the injection valve member, the actuator must overcome a powerful opening force. The powerful opening force that the actuator must exert results from the fact that the injection valve member, which can be embodied in the form of a nozzle needle, is acted on by system pressure (pressure level in the high-pressure accumulator/common rail) and is pressed into its seat. The force required to lift the injection valve member away from its seat is on the order of magnitude of several hundred N, e.g. approx. 400 N. In order to assure a sufficient flow of fuel through the injection openings into the combustion chamber of an autoignition engine when the injection valve member is completely open, it is also necessary for the injection valve member to execute a maximum stroke distance of several hundred μm, e.g. on an order of magnitude of between 200 μm and 300 μm. The values mentioned above, i.e. the force of several hundred N required to open the injection valve member and the maximum possible stroke distance of the injection valve member from its completely closed position to its completely open position, are essentially the determining parameters for the size of a piezoelectric actuator to be integrated into a fuel injector. Integration of a hydraulic boosting can in fact be used to vary the length/diameter ratio of the piezoelectric actuator, but the size of the actuator, also referred to as actuator volume, is essentially proportional to the opening force to be exerted and to a maximum stroke distance to be traveled by the injection valve member, which can be embodied in the form of a nozzle needle.

Embodiments known from the prior art have the disadvantage of the required high ratio of 1:3-4 necessary to control the stroke of the injection valve member within the required limits since the high boosting ratio significantly increases the size of a piezoelectric actuator.

### DEPICTION OF THE PRESENT INVENTION

According to the present invention, a multistage, for example two-stage, boosting is used to create an actuation option for an injection valve member that avoids the above-explained disadvantages. The embodiment according to the present invention makes it possible to shape the injection curve, which, in the lower partial stroke range of the injection valve member, is characterized by a 1:1-1.5-time boosting and thus makes it possible to achieve a precise, quick, and particularly stable actuation option. In the upper stroke range of the injection valve member, the boosting ratio increases to a higher level, e.g. 1:4-7.

The division of the boosting ratio into one ratio for a lower partial stroke range of the injection valve member and another ratio for the upper partial stroke range of the injection valve member can advantageously be implemented by providing a multistage pressure booster inside a fuel injector, which booster includes two pistons guided one inside the other, coupled to each other by a driver. The driver engages in a recess inside one of the pistons and the recess is sized so that only after a certain partial stroke has been executed does the driver engage an outer booster piston, which is supported in sliding fashion on an inner booster piston. The boosting ratio in the lower partial stroke range is determined by the diametrical ratio d₁ to d₂, i.e. the diametrical ratio between the diameter of the head region of the injection valve member and the diameter of an inner booster piston, whereas the effective boosting ratio in the upper partial stroke range of the injection valve member is determined by the diametrical ratio d₁ to d₃, i.e. the diametrical ratio between the diameter of the head region of the injection valve member and the outer diameter of a second booster piston, which is coupled to the first booster piston by means of the above-mentioned driver.

### DRAWING

The present invention will be described in detail below in conjunction with the drawing.

The sole FIGURE shows a cross section through a fuel injector with a multistage-controllable, directly actuated, nozzle needle-shaped injection valve member.

### EMBODIMENT VARIANTS

The FIGURE shows a fuel injector 1 that includes an injector body 2, an intermediate disk 3, and a nozzle body 4. The injector 2 and the nozzle body 4 are screw-connected to each other by means of a nozzle retaining nut 5; before the injector body 2 and nozzle body 4 are screw-connected to each other, the intermediate disk 3 is placed against the nozzle body 4, which disk is equipped with at least two flow conduits 26 and 40 that will be described in greater detail below.

In addition, the fuel injector 1 has a needle-shaped injection valve member 6, which can be comprised of one part or of several parts and which is able to open and close injection openings, not shown in the drawing, provided at the combustion chamber end of the fuel injector 1.

The intermediate disk 3 between the injector body 2 and the nozzle body 4 has an upper flat surface 7 oriented toward a lower flat surface of the injector body 2 and a lower flat surface 8 oriented toward the upper flat surface of the nozzle body 4.

The injector body 2 of the fuel injector 1 is also equipped with a cavity 9 that contains an actuator 39, which can be embodied, for example, in the form of a piezoelectric actuator comprised of a stack of piezoelectric crystals. The cavity 9 is fed by a fuel inlet 10 from a high-pressure accumulator (common rail), not shown in the drawing, that stores fuel at the system pressure. Via the fuel inlet 10, this fuel at system pressure (rail pressure) travels into the cavity 9 and flows from this along a multistage pressure booster 12 contained in the fuel injector 1 to the conduit 40 of the intermediate disk and from there, into the nozzle body 4.

The multistage pressure booster 12 is contained inside the cavity 9 of the fuel injector 1. The multistage pressure booster 12 includes a first booster piston 13 and a second booster piston 14, which encompasses the first booster piston 13 and is guided on it. The first booster piston 13, with the diameter d₂, contains a groove 30 for an annular driver 20, which engages in a recess 19 of the second booster piston 14 that encompasses the first booster piston 13. The recess 19 in the second booster piston 14 is delimited by a first stop side 21 and a second stop side 22.

The outer, second booster piston 14 has an end surface 16 acted upon by a spring element 15 that can be embodied in the form of a spiral spring and rests against a support disk 11, which is situated underneath the piezoelectric actuator 39 and moves vertically when the actuator 39 is supplied with current. The support disk 11 is supported by a tubular spring 17 whose end oriented away from the support disk 11 rests against the upper flat surface 7 of the intermediate disk 3. The tubular spring 17 moves the support disk 11 back into its initial position upon disconnection of the current supply to the piezoelectric crystal stack of the actuator 39. The tubular spring 17 between the support disk 11 and the upper flat surface 7 of the intermediate disk 3 encompasses a stop sleeve 18. The stop sleeve 18 extends beneath a shoulder of the second booster piston 14 and encompasses a spring 28 that places a first control chamber sleeve 27, which delimits a control chamber 25, against the upper flat surface 7 of the intermediate disk 3 of the fuel injector 1. The spring 28 is permanently stressed by the fuel pressure prevailing in the cavity 9, thus assuring that the biting edge 29 embodied at the bottom end of the first control chamber sleeve 27 always rests against the upper flat surface 7 of the intermediate disk 3, thus sealing the control chamber 25. The fuel contained in the control chamber 25, which is correspondingly compressed in accordance with the insertion movement of the first booster piston 13, the second booster piston 14, or both pistons into the control chamber 25, flows from the control chamber 25 via the conduit 26 to a hydraulic chamber, which is situated beneath the lower flat surface 8 of the intermediate disk 3 and hydraulically acts on a head 31 of the needle-shaped injection valve member 6.

On the one hand, the control chamber 25 is acted on by the upper flat surface 7 of the intermediate disk 3 and on the other hand, it is acted on by both the end surface 23 of the first booster piston 13 and the end surface 24 of the second booster piston 14.

The injection valve member 6, which can be embodied in the form of a needle and is situated underneath the intermediate disk 3, has a head 31 that is embodied with a diameter d₁. In comparison to this diameter d₁, the second booster piston 14 has an outer diameter d₃, which is greater than both the diameter d₂ of the first booster piston 13 and the diameter d₁ of the needle-shaped injection valve member 6. The hydraulic chamber between the lower flat surface 8 of the intermediate disk 3 and the upper end surface of the needle-shaped injection valve member 6 is delimited by a second control chamber sleeve 32. The second control chamber sleeve 32 in turn is acted on by a spring 33 that rests against a support ring 34, which can, for example, be shrink-fitted onto the circumference surface of the needle-shaped injection valve member 6, i.e. is attached to the circumference surface of the needle-shaped injection valve member 6 by means of a press fit. Beneath the support ring 34, the circumference of the needle-shaped injection valve member 6 is provided with two or more open surfaces 36 via which fuel flows toward an annular gap 37 in the flow direction 38. The injection openings, not shown in the drawing, at the combustion chamber end of the fuel injector 1 are situated underneath the annular gap 37 between the needle-shaped injection valve member 6 and the nozzle body 4.

Depending on the embodiment of the needle-shaped injection valve member 6, the open surfaces 36 can be offset from one another by 120° when three open flow surfaces 36 are provided on the needle-shaped injection valve member 6 and can be offset from one another by 90° when four open flow surfaces 36 are provided.

When the injection valve member 6 is in the closed state, the piezoelectric crystal stack of the actuator 39 is supplied with current and thus elongates in the vertical direction. As a result, the support disk 11 is deflected downward in the vertical direction and acts on the tubular spring 17 so that the latter is prestressed in opposition to the vertical stroke direction of the actuator 39. The supply of current to the piezoelectric crystal stack of the actuator 39 causes both the first booster piston 13 and the second booster piston 14 of the multistage pressure booster 12 to move into the control chamber 25. An increased pressure therefore prevails in this chamber and, via the conduit 26 in the intermediate disk 3, acts on the hydraulic chamber above the head 31 of the needle-shaped injection valve member 6. If the supply of current to the actuator 39 is then reduced, the piezoelectric crystal stack of the actuator 39 contracts and its elongation in the vertical direction decreases. The prestressed tubular spring 17 causes the support disk 11 to move upward in the vertical direction in accordance with the decrease in the elongation of the piezoelectric crystal stack of the actuator 39 so that the end surface 23 of the first booster piston 13 oriented toward the control chamber 25 travels out of the control chamber 25, reducing the pressure therein. Due to the decrease of pressure in the control chamber 25 and its hydraulic connection to the hydraulic chamber above the head 31 of the needle-shaped injection valve member 6, the needle-shaped injection valve member 6 also travels upward, thus unblocking the injection openings. Within the above-outlined partial stroke range, the multistage pressure booster 12 operates with a 1:1-1.5 boosting ratio. The boosting ratio within the above-outlined partial stroke range is defined by the diameter d₁/d₂, where d₁ is the diameter of the head 31 of the needle-shaped injection valve member 6 and d₂ is the outer diameter of the first booster piston 13 of the multistage pressure booster 12. The 1:1-1.5 boosting ratio in effect in this partial stroke range permits a quick, precise, and stable opening of the injection openings at the combustion chamber end of the fuel injector 1.

If the supply of current to the actuator 39 is further reduced, then its piezoelectric crystal stack contracts further, i.e. its elongation in the vertical direction is further reduced. As a result, the end surface 23 of the first booster piston 13 acting on the control chamber 25 moves even further out from the control chamber 25. If the top surface of the annular driver 20 strikes against the first stop side 21 of the recess 19 in the second booster piston 14, then after the stroke labeled h₁ has been exceeded, the driver 20 drives the second booster piston 14 upward, which is supported in sliding fashion on the circumference of the first booster piston 13. As a result, the annular end surface 24 of the second booster piston 14, which likewise acts on the control chamber 25, also travels farther out from the control chamber 25. After the stroke h₁ has been exceeded, then the multistage pressure booster functions with a second boosting ratio of 1:4-7, which is defined by the diameter ratio d₁/d₃, where d₁—as mentioned above—is the diameter of the head 31 of the needle-shaped injection valve member 6 and d₃ is the outer diameter of the second booster piston 14 that is able to move in sliding fashion on the first booster piston 13. Because of the fact that after the stroke h₁ has been exceeded, the end surfaces 23 and 24 both travel out from the control chamber 25, the pressure in the control chamber 25 falls more quickly compared to the state in which only the end surface 23 of the first booster piston 13 travels out from the control chamber 25. For this reason, a small actuator stroke is able to achieve a complete opening of the needle-shaped injection valve member 6 by moving a larger hydraulic surface (23+24), which is important in the full load range of the internal combustion engine.

But if the piezoelectric crystal stack of the actuator 39 is supplied with current again, then an elongation of the crystal stack occurs in accordance with the level of current supplied to the piezoelectric crystal stack, which presses against the support disk 11 in opposition to the action of the tubular spring 17 that rests against the upper flat surface 7 of the intermediate disk 3. The tubular spring 17 encompasses the stop sleeve 18, whose upper edge in turn engages underneath a shoulder on the outer circumference of the second booster piston 14 and defines its starting position. If the support disk 11 travels vertically downward due to the elongation of the piezoelectric crystal stack of the actuator 39, then first, the end surface 23 of the inner, first booster piston 13 is moved into the control chamber 25 and, as soon as the underside of the driver 20 rests against the second stop side 22 of the recess 19, the second booster piston 14 is also moved into its starting position, which is defined by the stop sleeve 18 that likewise rests against the upper flat surface 7 of the intermediate disk 3.

Fuel at system pressure (rail pressure) flows through the inlet 10 into the cavity 9 inside the injector body 2 and flows through the conduit 40 provided in the intermediate disk 3 into the nozzle body 4. Due to the action of the biting edge 29 on the first control chamber sleeve 27 and the biting edge 35 of the second control chamber sleeve 32, the control volume contained in the control chamber 25 and the hydraulic chamber above the head 31 of the needle-shaped injection valve member 6 is separated from the fuel flowing to the injection valve member 6.

The fuel flows via the conduit 40 into the nozzle body 4 and, via the open surface 36 provided on the circumference of the needle-shaped injection valve member 6, flows into an annular gap 37, which is delimited between the outer circumference of the needle-shaped injection valve member 6 and the inside of the nozzle body 4. The fuel volume traveling in the flow direction 38 flows to the injection openings provided at the combustion chamber end of the fuel injector 1 and, when the injection valve member 6 is either open or only partially open, travels through these openings into the combustion chamber of the autoignition internal combustion engine.

The embodiment according to the present invention is distinguished primarily by the fact that in the first partial stroke range of the needle-shaped injection valve member 6, an opening of the needle-shaped injection valve member can be implemented with a high degree of rigidity, generated by the low boosting of 1:1-1.5 between the actuator stroke and the injection valve member. Consequently, the opening of the injection openings situated at the combustion chamber end occurs in a controlled fashion in the first partial stroke range of the injection valve member, i.e. quantity jumps in the fuel quantity delivered to the combustion chamber—which jumps occur due to excessively rapid opening of the needle-shaped injection valve member 6—are avoided so that soot production during combustion decreases significantly. The tandem pressure-relieving movement of the two booster pistons 13, 14 of the multistage pressure booster 12 once the partial stroke h₁ has been achieved results in a higher boosting ratio of between 1:4 and 1:7 of the multistage pressure booster 12 after the stroke h₁ has been exceeded in the opening direction. Consequently, a small actuator stroke can result in a further opening of the needle-shaped injection valve member 6 with greater boosting since the end surfaces 23 and 24 are being moved in tandem.

By contrast with the embodiments known from the prior art, the embodiment according to the present invention makes it possible to significantly reduce the structural volume of the actuator. The two boosting ratios corresponding to the partial strokes of the needle-shaped injection valve member 6-1:1-1.5 in the first partial stroke range and 1:4-7 in the other partial stroke range—make it possible to shape the curve of the injection into the combustion chamber of the autoignition internal combustion engine; in particular, the embodiment takes into account the requirement for accommodating the actuator 39, which triggers the needle-shaped injection valve member 6, inside the cavity 9 of the fuel injector 1 in as space-saving a fashion as possible.

### REFERENCE NUMERAL LIST

1 fuel injector
2 injector body
3 intermediate disk
4 nozzle body
5 nozzle retaining nut
6 injection valve member
7 upper flat surface
8 lower flat surface
9 cavity
10 fuel inlet (from common rail)
11 support disk
12 multistage pressure booster
13 first booster piston
14 second booster piston
15 spring element for first booster piston
16 end surface of second booster piston 14
17 tubular spring
18 stop sleeve
19 recess
20 driver h₁ preliminary stroke of driver 20
21 first stop side of recess 19
22 second stop side of recess 19
23 end surface of first booster piston 13
24 end surface of second booster piston 14
25 control chamber
26 conduit
27 first control chamber sleeve
28 spring
29 biting edge of 27
d₁ head diameter of injection valve member 6
d₂ diameter of first booster piston 13
d₃ diameter of second booster piston 14
30 accommodating groove for driver 20
31 head of injection valve member 6
32 second control chamber sleeve
33 spring
34 support ring
35 biting edge of 32
36 open surfaces (120°, 90°)
37 annular gap
38 direction of fuel flow
39 actuator

1-12. (canceled)

13. In a fuel injector having an injector body, a valve body, and an a needle-shaped injection valve member for injecting fuel into the combustion chamber of an autoignition internal combustion engine, the injection valve member being triggerable by means of an actuator that directly actuates a pressure booster to influence the pressure in a control chamber that acts on the injection valve member, the improvement wherein the pressure booster is a multistage booster having a first booster piston and a second booster piston, the first and second booster pistons being coupled to each other by means of a driver that is able to move between a first stop side and a second stop side inside a recess.

14. The fuel injector according to claim 13, wherein the second booster piston of the multistage pressure booster is supported in sliding fashion on the outer surface of the first booster piston.

15. The fuel injector according to claim 13, further comprising a tubular spring element, supported in the injector body and acting on a transition element associated with the booster pistons.

16. The fuel injector according to claim 13, wherein within a first partial stroke range of the needle-shaped injection valve member, which corresponds to a preliminary stroke h₁, when the supply of current to the actuator is reduced, the first booster piston travels out from the control chamber.

17. The fuel injector according to claim 13, wherein after a first partial stroke range of the needle-shaped injection valve member, which first partial stroke corresponds to a preliminary stroke h₁, is exceeded, the driver moves the second booster piston out from the control chamber in tandem with the first booster piston.

18. The fuel injector according to claim 16, wherein the preliminary stroke h₁ corresponds to the distance of a flat side of the driver from a first stop side of a recess in the second booster piston.

19. The fuel injector according to claim 13, wherein the control chamber, which can be acted on either by the end surface of the first booster piston or by the end surfaces of the first booster piston and second booster piston, is hydraulically connected via a hydraulic conduit to a hydraulic chamber above a head region of the needle-shaped injection valve member.

20. The fuel injector according to claim 19, wherein both the control chamber and the hydraulic chamber above the needle-shaped injection valve member are delimited by means of first and second spring-loaded control chamber sleeves.

21. The fuel injector according to claim 20, further comprising a biting edge of the first control chamber sleeve resting against an upper flat surface of an intermediate disk of the fuel injector.

22. The fuel injector according to claim 20, further comprising a the biting edge of the second control chamber sleeve resting against the lower flat surface of an intermediate disk of the fuel injector.

23. The fuel injector according to claim 21, further comprising a the biting edge of the second control chamber sleeve resting against the lower flat surface of an intermediate disk of the fuel injector.

24. The fuel injector according to claim 21, further comprising a spring that places the first control chamber sleeve against the upper flat surface of the intermediate disk rests against an annular shoulder of the second booster piston, which is supported in sliding fashion on the first booster piston.

25. The fuel injector according to claim 15, further comprising a spring element supported against the transmission element below the actuator and acting on an end surface of the second booster piston of the multistage pressure booster.
